(19) United States
(12) Patent Application Publication
(10) Pub. No.: US 2005/0091677 A1
(43) Pub. Date: Apr. 28, 2005

(54) Disk cartridge

(75) Inventor: Fumihito Imai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/969,976

(22) Filed: Oct. 22, 2004

(30) Foreign Application Priority Data
Oct. 22, 2003 (JP) 2003-361509

(51) Int. Cl. G11B 23/03

(52) U.S. Cl. 720/741

(57) ABSTRACT

A parallelepiped urging portion is fixed, via an adhesive, to a distal end surface of a first stopper of a top shell of a disk cartridge. In a state of locking by a locking member, the urging portion is pushed by a step portion of a closing side stopper, and elastic force accumulates at the urging portion. In this state, when the state of locking by the locking member is released, the urging portion is restored, an inner rotor is urged, via the closing side stopper, in the direction in which an opening opens, and the inner rotor is rotated in a direction of opening the opening.

### CROSS-REFERENCE TO RELATED APPLICATION

This application claims priority under 35 USC 119 from Japanese Patent Application No. 2003-361509, the disclosure of which is incorporated by reference herein.

### BACKGROUND OF THE INVENTION

1. Technical Field

The present invention relates to a disk cartridge which is loaded into a drive device and which accommodates a disk medium on which information can be recorded and from which information can be played back.

2. Description of the Related Art

When recording or playback is carried out, a disk medium is rotated in a state of being loaded in a drive device, and laser light is illuminated onto the recording surface by a lens which is provided at an optical pick-up. In this way, recording of information is carried out by the formation of pits due to decomposition of the pigment layer of the recording surface, or by phase changes, magnetism or the like, or playback of the recorded information is carried out on the basis of the differences in the polarizing angles or the reflectances of the laser light.

In recent years, as disk media have come to have higher densities, a case has been used in order to protect the disk medium from dust, and the disk medium can be accommodated within the case. A first opening portion is cut-out in the case. This first opening portion can be opened and closed by a pair of shutters which are accommodated in the case and which are provided so as to be slidable with respect to the case. In this way, by opening the first opening portion by the shutters, a portion of the optical disk can be exposed.

Here, in order to prevent the shutters from being easily opened from the outer side, a disk cartridge has been proposed in which an inner rotor is accommodated within the case so as to be freely rotatable, and the shutters are opened and closed interlockingly with the rotation of the inner rotor.

Specifically, a second opening portion, which is substantially the same size as the first opening portion, is formed in the inner rotor. The shutters are supported by shafts so as to be able to swing toward the inner rotor, and the shutters can open and close the second opening portion.

Guide projections project at a bottom shell. Cam holes, with which the guide projections can engage, are formed in the shutters. When the inner rotor rotates, the shutters rotate interlockingly therewith, and the shutters swing around the shafts with respect to the inner rotor via the cam holes, with the guide projections serving as references, such that the first opening portion and the second opening portion are opened and closed.

Here, the coefficient of static friction is large as compared with the coefficient of dynamic friction. Thus, when the inner rotor rotates, the rotation is unstable at the initial motion thereof. Therefore, in Japanese Patent Application Laid-Open (JP-A) No. 2003-30948, a first shutter member (suitable for the inner rotor) is always urged, via a circular-arc-shaped guide wall portion and by a coil spring, in a direction of rotating along a tub wall with a jutting portion leading.

Then, when the disk cartridge is loaded into a drive device, a guiding convex portion of the drive device engages with a shutter engaging portion, and the shutter engaging portion moves rearward. Against the urging force of the coil spring (the elastic force of the coil spring accumulates), the circular-arc-shaped guide wall portion slides along the tubular wall via a shutter pull-out portion, and a shutter main body rotates in the direction of opening an opening.

When the disk cartridge is to be discharged from the drive device, the moving force (the pulling force or pulling force) applied to the first shutter member from the exterior (the guiding convex portion) is eliminated. Therefore, due to the peripheral direction urging force of the coil spring which has been compressed along the tubular wall, the circular-arc-shaped guide wall portion moves along the tubular wall, and the shutter main body rotates in the direction of closing the opening.

In this way, due to the circular-arc-shaped guide wall portion being urged by the coil spring, with a simple structure, urging force along the peripheral direction of the tubular wall is suitably applied to the first shutter member which does not have a revolution shaft, and the first shutter member is reliably operated.

In the above-described publication, the coil spring urges the circular-arc-shaped guide wall portion in the direction of closing the opening. Therefore, in order to open the opening, the circular-arc-shaped guide wall portion must be moved against the urging force of the coil spring.

In order to move the circular-arc-shaped guide wall portion, a force which gradually increases in proportion to the moved amount of the circular-arc-shaped guide wall portion is needed.

Further, the coil spring must always urge the circular-arc-shaped guide wall portion. Therefore, in consideration of the amount of movement of the circular-arc-shaped guide wall portion, the coil spring must have a length corresponding to the amount of movement of the circular-arc-shaped guide wall portion. With a coil spring whose length satisfies this condition, there is the concern that the coils thereof may easily become entangled.

### SUMMARY OF THE INVENTION

A disk cartridge, in which the rotation of an inner rotor at the time of opening an opening is smooth and which has good assembly workability, is desired.

A first aspect of the present invention is a disk cartridge. This cartridge has: a disk medium which is loaded in a drive device, and on which information is recorded by laser light, and from which information is played-back by laser light; a case rotatably accommodating the disk medium; a first opening portion formed in the case, and enabling projection of laser light onto a recording surface of the disk medium; an inner rotor rotatably accommodated within the case, a second opening portion of substantially a same size as the first opening portion being formed in the inner rotor; a shutter supported swingably by a shaft at the inner rotor, and opening and closing the first opening portion and the second opening portion; an urging portion at which elastic force accumulates in a state in which the first opening portion and the second opening portion are closed, and in the state in which the first opening portion and the second opening portion are closed, the urging portion abuts the inner rotor such that elastic force accumulates at the urging portion, and the urging portion urges the inner rotor in a direction of opening the first opening portion and the second opening portion; and a locking portion locking the inner rotor in the state in which the first opening portion and the second opening portion are closed.

In the present invention, the disk medium, which is loaded in a drive device and on which information is recorded by laser light and from which information is played-back by laser light, is rotatably accommodated in the case. The first opening portion is formed in the case, such that laser light can be projected onto the recording surface of the disk medium.

The inner rotor, in which is formed the second opening portion which is substantially the same size as the first opening portion, is rotatably accommodated within the case. The shutter is supported swingably by a shaft at the inner rotor, and opens and closes the first opening portion and the second opening portion.

Here, in the state in which the first opening portion and the second opening portion are closed, the inner rotor is locked by the locking portion. The urging portion, which, in this state, abuts the inner rotor such that elastic force accumulates at the urging portion, is provided, and urges the inner rotor in the direction in which the first opening portion and the second opening portion open.

Therefore, when the state of locking by the locking portion (the state in which the first opening portion and the second opening portion are closed) is cancelled, the accumulated elastic force is restored, and urges the inner rotor in the direction in which the first opening portion and the second opening portion open. The inner rotor thereby rotates in the direction of opening the first opening portion and the second opening portion.

In this way, at the time when the first opening portion and the second opening portion are opened, the inner rotor is urged by the elastic force of the urging portion. The rotation of the inner rotor at the time of opening the first opening portion and the second opening portion can thereby be made to be smooth.

### BRIEF DESCRIPTION OF THE DRAWINGS

FIG. 1 is a perspective view showing the exterior of a disk cartridge relating to an embodiment of the present invention.

FIG. 2 is an exploded perspective view of the disk cartridge relating to the embodiment of the present invention.

FIG. 3 is an exploded perspective view, as seen from below, of an inner rotor and the like structuring the disk cartridge relating to the embodiment of the present invention.

FIG. 4 is a bottom view of a top shell structuring the disk cartridge relating to the embodiment of the present invention.

FIG. 5 is a plan view of a bottom shell structuring the disk cartridge relating to the embodiment of the present invention.

FIG. 6 is a bottom view of the inner rotor structuring the disk cartridge relating to the embodiment of the present invention.

FIG. 7 is a perspective view, as seen from below, of the inner rotor and a shutter member structuring the disk cartridge relating to the embodiment of the present invention.

FIG. 8 is a bottom view, as seen with the bottom shell removed, showing a state in which an opening of the disk cartridge relating to the embodiment of the present invention is closed.

FIG. 9 is a bottom view, as seen with the bottom shell removed, showing the process of closing or opening the opening of the disk cartridge relating to the embodiment of the present invention.

FIG. 10 is a bottom view, as seen with the bottom shell removed, showing a state in which the opening of the disk cartridge relating to the embodiment of the present invention is open.

FIG. 11 is a plan view showing the inner rotor and the bottom shell in the state in which the opening of the disk cartridge relating to the embodiment of the present invention is closed.

FIG. 12 is an exploded perspective view showing main portions of the top shell and the inner rotor in the state in which the opening of the disk cartridge relating to the embodiment of the present invention is closed.

FIG. 13A is an explanatory diagram showing main portions of the top shell and the inner rotor, and a state immediately before the state in which the opening is closed or a state immediately after locking by a locking member has been released.

FIG. 13B shows a state in which the opening of the disk cartridge of FIG. 13A is closed.

FIG. 14 is an exploded perspective view showing a modified example of main portions of the top shell of the disk cartridge relating to the embodiment of the present invention.

FIG. 15 is a plan view showing a modified example of main portions of the bottom shell of the disk cartridge relating to the embodiment of the present invention.

### DETAILED DESCRIPTION OF THE INVENTION

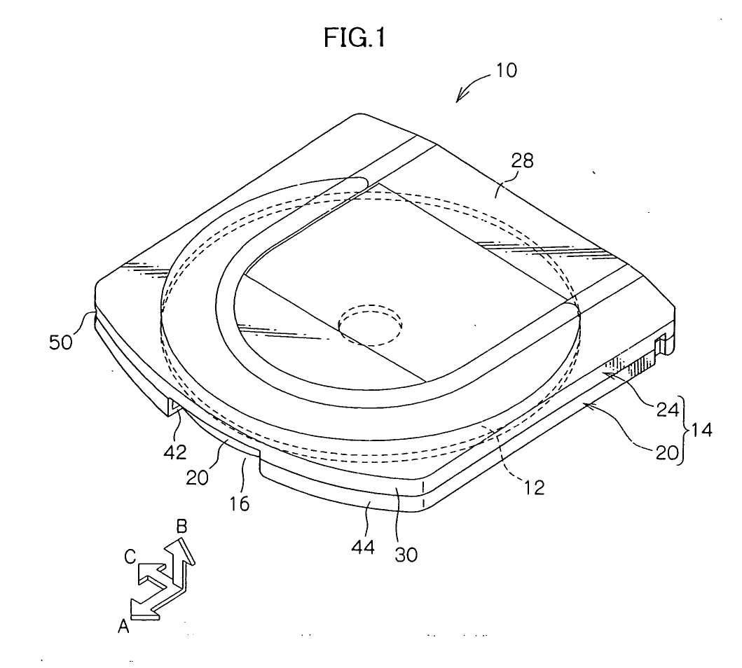

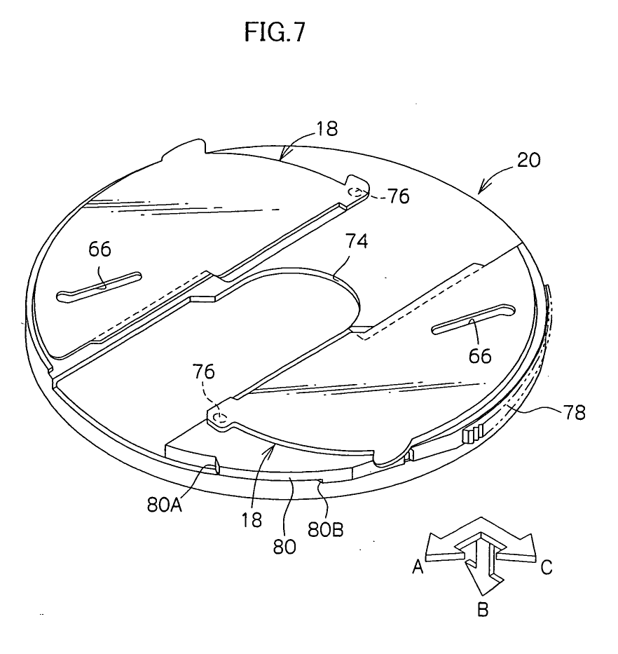

A disk cartridge 10 relating to an embodiment of the present invention will be described on the basis of FIGS. 1 through 10. Arrow A shown appropriately in the respective drawings indicates the direction of loading the disk cartridge 10 into a drive device, and for convenience, explanation will be given by referring to the side shown by arrow A, which is the direction of loading the disk cartridge 10 into a drive device, as the front side. Further, the direction indicated by arrow B is the top side, and the direction indicated by arrow C is the right side.

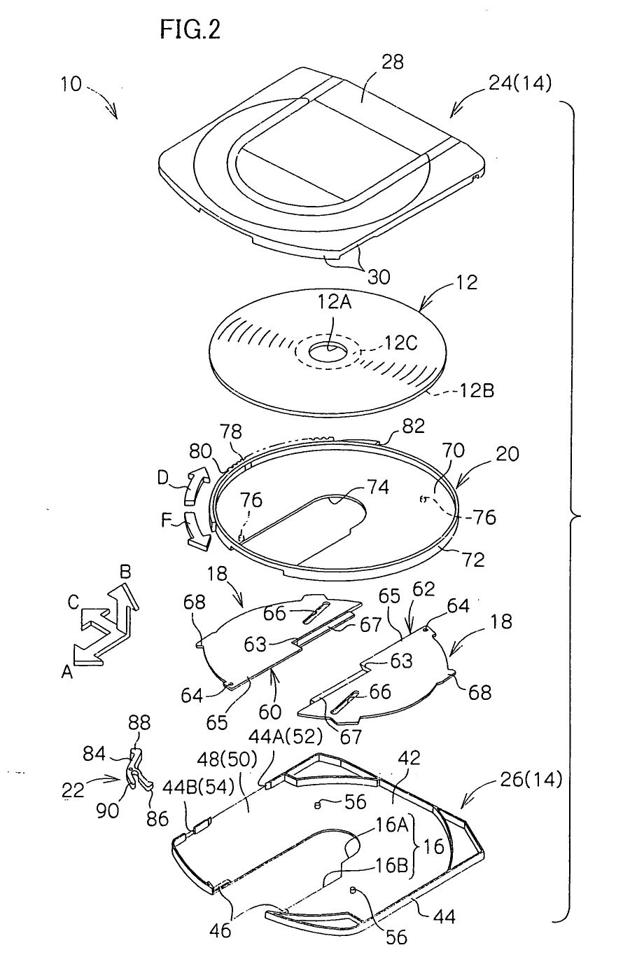

In FIG. 1, the external configuration of the disk cartridge 10 is shown in perspective view. In FIG. 2, the disk cartridge 10 is shown in exploded perspective view. As shown in these drawings, the disk cartridge 10 is structured to include the following as the main structural elements thereof: a disk medium 12 serving as an information recording/playback medium and formed in the shape of a disc; a case 14 structured by a top shell 24 and a bottom shell 26, and rotatably accommodating the disk medium 12; a pair of shutter members 18 which can open and close an opening 16 which is formed in the bottom shell 26 for access to the disk medium 12; an inner rotor 20 which is rotated by a drive device and drives the shutter members 18 to open and close the opening 16 (a first opening portion); and a locking member 22 which, when the disk medium 12 is not in use, impedes rotation of the inner rotor 20 so as to maintain the closed state of the opening 16.

Hereinafter, the basic overall structure of the disk cartridge 10 will be described in this order, and thereafter, the detailed structure of the main portions of the present invention will be described.

Overall Structure of Disk Cartridge

As shown in FIG. 2, the disk medium 12 has, at the axially central portion thereof, a center hole 12A which is engaged and held by a rotating spindle shaft of an unillustrated disk drive device. A recording surface 12B, which is formed at the bottom surface of the disk medium 12, is covered and protected by a cover layer (both the bottom surface and the cover layer are omitted from illustrated in FIG. 2).

The recording surface 12B is formed in an annular shape at the portion of the bottom surface of the disk medium 12, except for in a vicinity of the outer periphery and at a predetermined range around the center hole 12A. The region at the bottom surface of the disk medium 12 between the center hole 12A and the recording surface 12B is a chucking area 12C for the rotating spindle shaft of the drive device to hold the disk medium 12. Note that, in the present embodiment, the diameter (outer diameter) of the disk medium 12 is substantially 120 mm.

The case 14 which accommodates the disk medium 12 is structured as a substantially square, flat container, by the top shell 24 and the bottom shell 26 being joined together. Specifically, in plan view, the front edge portion of the case 14 is curved in a circular-arc-shape which is substantially symmetrical to the left and the right, and the both corner portions at the rear end are cut-off obliquely. Such a configuration prevents the disk cartridge 10 from being incorrectly loaded into a drive device.

The case 14 will be described concretely hereinafter.

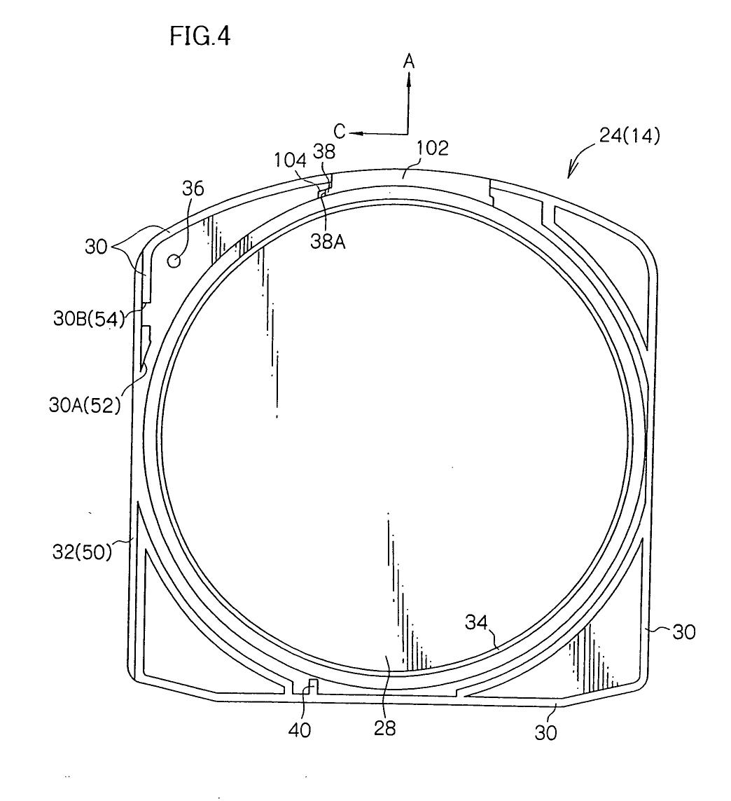

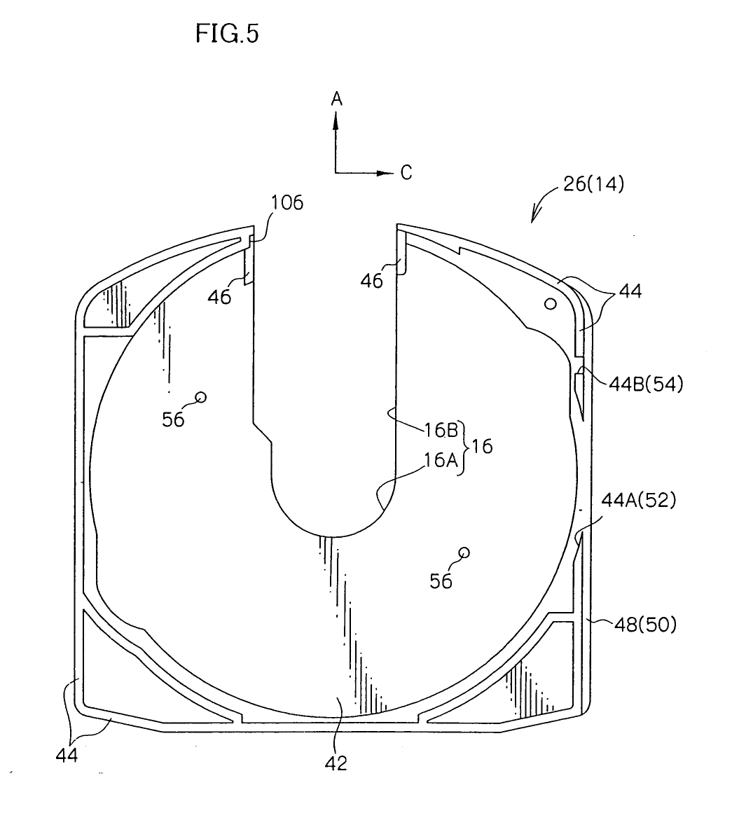

As shown in FIG. 4, the top shell 24 has a ceiling plate 28 having a configuration corresponding to the configuration of the case 14 in plan view, and a peripheral wall 30 which stands erect downwardly substantially along the outer edge of the ceiling plate 28. A top side groove wall 32, which juts out further at the right than the right side of the peripheral wall 30, extends at the right end portion of the ceiling plate 28 along substantially the entire length in the front-back direction. This top side groove wall 32, together with a bottom side groove wall 48 (which will be described later) of the bottom shell 26 shown in FIG. 5, structures a guide groove 50 which is at the right side portion of the case 14, and whose longitudinal direction is the front-back direction, and which opens to the front and to the right.

An inner wall 34, which is formed in an annular shape in bottom view, stands erect at the inner side of the peripheral wall 30 at the bottom surface of the ceiling plate 28. Here, at the top shell 24, the disk medium 12 is accommodated at the inner side of the inner wall 34. The outer peripheral surface of the inner wall 34 is a guide surface with which an annular wall 72 (to be described later) of the inner rotor 20 shown in FIG. 2 fits together so as to be slidable in the peripheral direction.

A cut-out portion 30A, which is formed by cutting out the substantially central portion, in the front-back direction, of the right side portion of the top shell 24, is provided in the peripheral wall 30. Together with a cut-out portion 44A (which will be described later) of the bottom shell 26, the cut-out portion 30A structures a shutter operation window 52 which exposes the inner rotor 20 to the exterior (the guide groove 50).

A lock supporting shaft 36, which swingably supports the locking member 22 shown in FIG. 2, projects from the front right corner portion of the bottom surface of the ceiling plate 28. This lock supporting shaft 36 is positioned between the peripheral wall 30 and the inner wall 34. A cut-out portion 30B is formed by cutting-out a portion of the peripheral wall 30 at the rear side of the lock supporting shaft 36 and the front side of the cut-out portion 30A. Together with a cut-out portion 44B (which will be described later) of the bottom shell 26, the cut-out portion 30B structures a lock release window 54 which is for causing a release operation portion 88 of the locking member 22 to project out in the guide groove 50.

A pedestal 102, which is slightly lower than the peripheral wall 30, stands erect continuously from the peripheral wall 30 at the central portion of the front side at the bottom surface of the ceiling plate 28. A predetermined distance, which is such that the inner rotor 20 can be disposed, is provided between the pedestal 102 and the outer peripheral surface of the inner wall 34. A first stopper 38 projects along the peripheral direction of the annular wall 72, at the inner wall 34 side of the right end portion of the pedestal 102, and is for restricting rotation of the inner rotor 20 toward the closing side.

Here, a polyurethane foamed member 104, which is formed in the shape of a parallelepiped flat plate, is fixed by an adhesive or double-sided tape or the like to a distal end surface 38A in the projecting direction of the first stopper 38. Details thereof will be described later.

At a portion in a vicinity of the rear end of the bottom surface of the ceiling plate 28, which portion is slightly further toward the right side than the left-right direction central portion, a second stopper 40 is provided continuously from the rear side portion of the peripheral wall 30. The second stopper 40 is for restricting rotation of the inner rotor 20 toward the open side.

As shown in FIGS. 2 and 5, the bottom shell 26 has a floor plate 42 which is of a configuration substantially corresponding to the ceiling plate 28 of the top shell 24, and a peripheral wall 44 which is of a configuration substantially corresponding to the peripheral wall 30 of the top shell 24. The aforementioned opening 16 is provided in the floor plate 42.

The opening 16 is structured by a hub hole 16A and a window portion 16B for a recording/playback head. The hub hole 16A is substantially circular, and has a larger diameter than the outer diameter of the center hole 12A of the disk medium 12, and a slightly smaller diameter than the outer diameter of the chucking area 12C (the inner diameter of the recording surface 12B). The window portion 16B for a recording/playback head is substantially rectangular, and is formed continuously with the hub hole 16A at the front side of a central line which runs along the left-right direction. The opening 16 is thereby formed overall in a substantial U-shape which opens toward the front.

Here, in the state in which the top shell 24 and the bottom shell 26 are joined together, the hub hole 16A is disposed so as to be substantially coaxial to the disk medium 12 which is accommodated at the inner side of the inner wall 34. By forming the hub hole 16A to have the above-described dimensions, only the center hole 12A and the chucking area 12C are exposed to the exterior, and the recording surface 12B is not exposed to the exterior.

The window portion 16B for a recording/playback head, which is for exposing the recording surface 12B, is formed to have a widened width such that the left edge thereof is positioned further toward the left than a line which runs along the front-back direction and is tangent to the hub hole 16A. The front portion of the window portion 16B for a recording/playback head is open also at the front of the bottom shell 26 by cutting away the peripheral wall 44.

The rotating spindle shaft of the drive device enters into the hub hole 16A, and rotates and drives the disk medium 12 while engaging and holding the center hole 12A of the disk medium 12. A recording/playback head of the drive device enters into the window portion 16B for a recording/playback head, and carries out recording or playback of information with respect to the recording surface 12B of the disk medium 12.

Due to the window portion 16B for a recording/playback head being open toward the front as well, the recording/playback head can easily access as far as the outer peripheral portion of the recording surface 12B. Note that the hub hole 16A and the window portion 16B for a recording/playback head may be provided independently of one another.

Dustproofing ribs 46, whose front ends are continuous with the peripheral wall 44, stand erect at the floor plate 42 in vicinities of the front ends of both of the left and right edge portions of the window portion 16B for a recording/playback head. The height of each of the dustproofing ribs 46 is equivalent to the thickness of the shutter members 18. The inner rotor 20 slides along the top surfaces of the dustproofing ribs 46.

The positions of the rear end portions of the dustproofing ribs 46 are determined so as to contact the respective shutter members 18 which are closing the opening 16. Here, a third stopper 106 stands erect continuously from the front side of the peripheral wall 44, at the top surface of the left side of the front end of the dustproofing rib 46 which is at the left side. The third stopper 106 is for restricting rotation of the inner rotor 20 toward the closing side. Details thereof will be described later.

The bottom side groove wall 48, which juts out further toward the right than the right side of the peripheral wall 44, extends at the right end portion of the floor plate 42 along substantially the entire length in the front-back direction. This bottom side groove wall 48 opposes the top side groove wall 32 of the top shell 24 shown in FIG. 4, such that the guide groove 50 is formed at the right side portion of the case 14.

The guide groove 50 is the groove floors of the peripheral walls 30, 44 whose top and bottom end surfaces abut one another due to the top shell 24 and the bottom shell 26 being joined together. As described above, the longitudinal direction of the guide groove 50 is along the front-rear direction of the case 14, and the guide groove 50 opens toward the front and the right. In the present embodiment, the guide groove 50 opens toward the rear as well.

A cut-out portion 44A formed so as to correspond to the cut-out portion 30A of the peripheral wall 30, and a cut-out portion 44B formed so as to correspond to the cut-out portion 30B of the peripheral wall 30, are formed in the peripheral wall 44 at the right side portion of the bottom shell 26.

In this way, the shutter operation window 52 which is open at the longitudinal direction central portion of the groove floor of the guide groove 50, and the lock release window 54 which is open at the groove floor of the guide groove 50 at the front side of the shutter operation window 52, are formed in the case 14 at which the top shell 24 and the bottom shell 26 are joined together.

A cam projection 56 projects at each of the left and right sides of the floor plate 42, at either side of the opening 16. The pair of cam projections 56 are disposed at positions which are symmetrical across the axial center of the hub hole 16A, and more correctly, symmetrical across the center of rotation of the inner rotor 20.

These cam projections 56 enter into cam grooves 66 (to be described later) of the different shutter members 18, and, together with the cam grooves 66, form positive motion cams. Due to relative rotation between the case 14 and the inner rotor 20, the shutter members 18 are moved between positions of closing the opening 16 and positions of opening the opening 16.

In the state in which the top end surface of the peripheral wall 44 abuts the bottom end surface of the peripheral wall 30, the above-described bottom shell 26 is joined together with the top shell 24 by screws, so as to structure the case 14. Note that, instead of being joined together by screws, the top shell 24 and the bottom shell 26 may be joined together by, for example, ultrasonically welding the peripheral walls 30, 44, or the like.

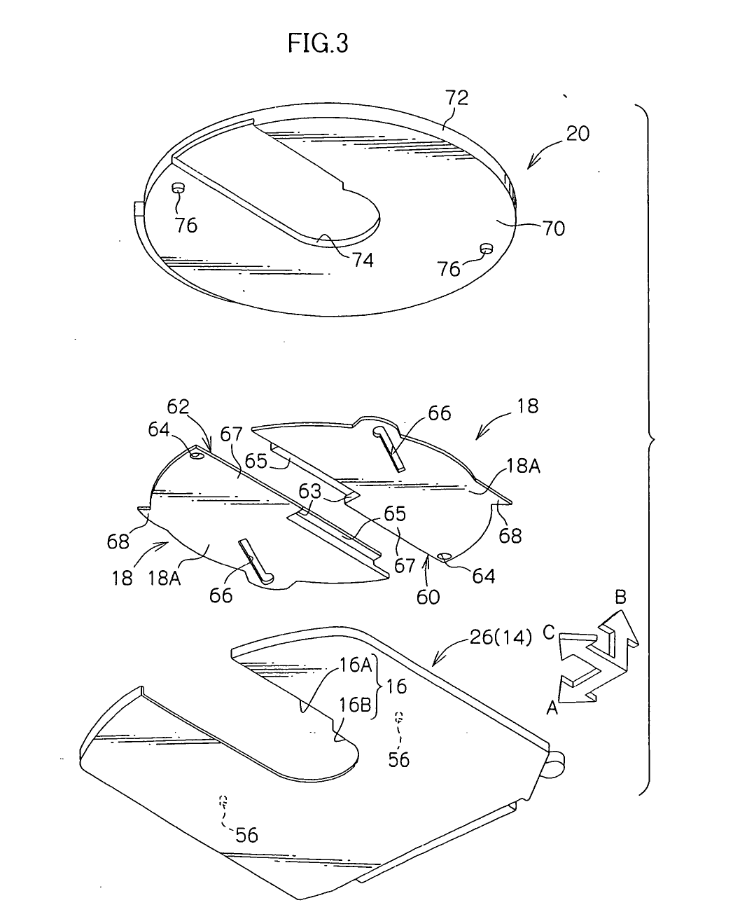

As shown in FIG. 3, each of the pair of shutter members 18 is formed substantially in the shape of a semicircular flat plate. Opposing portions 60, 62 thereof, which are chord portions, oppose one another, and are able to close a portion of the opening 16 formed in the bottom shell 26.

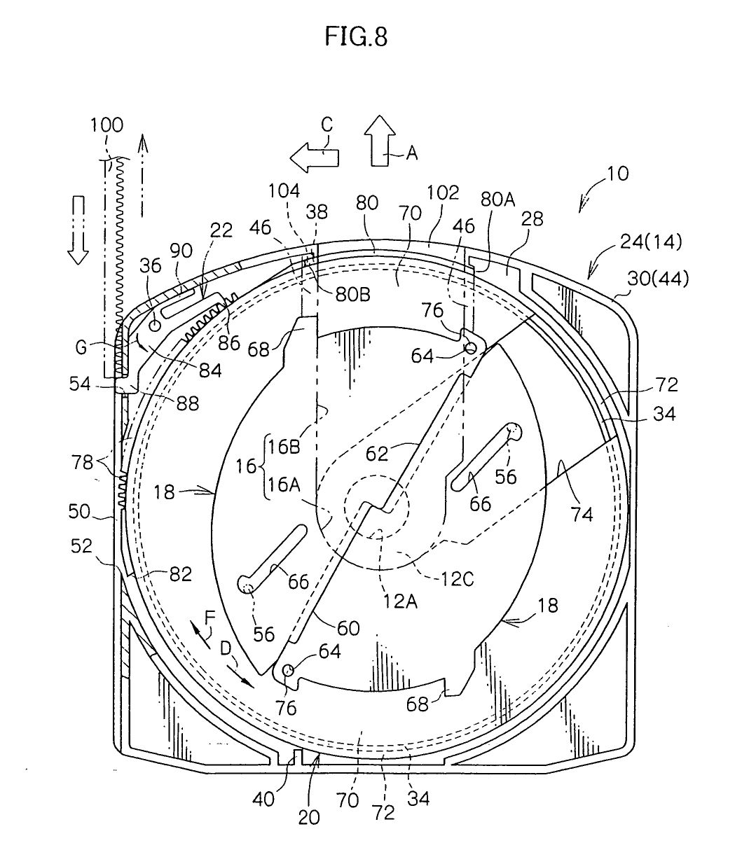

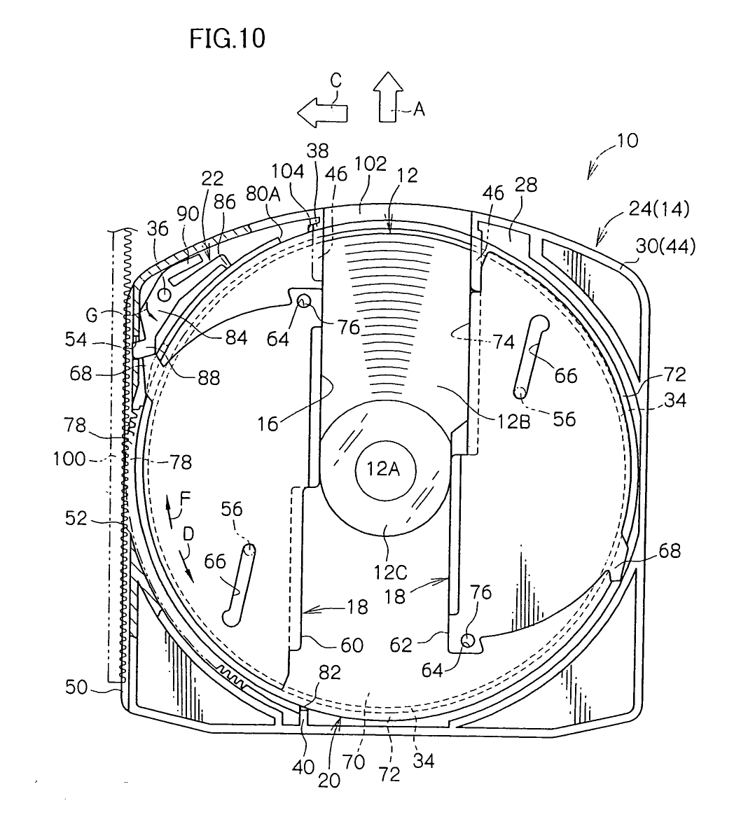

Namely, the pair of shutter members 18 are formed so as to be able to be set at closing positions (see FIG. 8), at which the opposing portions 60, 62 thereof are set in opposition to one another and close the hub hole 16A and a portion of the window portion 16B for a recording/playback head except for the portion thereof in the vicinity of the front end, and opening positions (see FIG. 10), at which the opposing portions 60, 62 are made to substantially coincide with the left and right edge portions of the opening 16 so as to open the opening 16.

Here, the opposing portions 60, 62 of the pair of shutter members 18 which are disposed at the closing positions are overlapped one on top of the other, so as to reliably impede entry of dust into the case 14.

Specifically, a step portion 63 is formed at each of the opposing portions 60, 62 of the shutter members 18. A visor portion 65, which is a thin portion running along the top surface, is formed at one longitudinal direction side of the step portion 63, whereas a visor portion 67, which is a thin portion running along the bottom surface, is formed at the other side.

When the pair of shutter members 18 are disposed at the closing positions, the visor portion 67 of one of the shutter members 18 overlaps at the bottom side of the visor portion 65 of the other shutter member 18, and the visor portion 65 of the one shutter member 18 overlaps at the top side of the visor portion 67 of the other shutter member 18. Here, the surface of each visor portion 65, 67 which overlaps with the opposing one is formed as a gently inclined surface so as to guide in that other one.

A shaft hole 64 is formed in the vicinity of one longitudinal direction end portion of the chord portion of each shutter member 18. The shaft holes 64 are for pivotally supporting the shutter members 18 at the inner rotor 20. The cam grooves 66, into which the cam projections 56 formed at the bottom shell 26 enter, are provided at the shutter members 18. Each cam groove 66 is formed in the shape of a rectilinear slit which is long along the direction of a straight line passing through the axial center of the shaft hole 64 at each shutter member 18. The cam grooves 66 are provided so as to be parallel to one another in the assembled state.

Namely, in the same way as the cam projections 56, the cam grooves 66 are provided so as to be symmetrical to one another across the rotational center of the inner rotor 20. The cam grooves 66 pass through the shutter members 18 in the direction of plate thickness thereof, such that a depth for engagement with the cam projections 56 is ensured.

A dustproofing portion 68, which juts out from the arc portion, is provided at at least one of the shutter members 18. When that one shutter member 18 is disposed at the closing position, the dustproofing portion 68 abuts the rear end surface of the dustproofing rib 46 positioned at the right edge side of the opening 16, and fills-in the gap between the top surface of the floor plate 42 and the bottom surface of a circular plate portion 70 (which will be described later) of the inner rotor 20 (see FIG. 8).

When the one shutter member 18 is disposed at the closing position, the end portion, in a vicinity of the shaft hole 64, of this one shutter member 18 abuts the rear end surface of the other dustproofing rib 46, and fills-in the gap between the top surface of the floor plate 42 and the bottom surface of the circular plate portion 70. Note that the dustproofing portion 68 may be provided at each of the shutter members 18.

As shown in FIGS. 2 and 3, the inner rotor 20 has the circular plate portion 70 which is formed in the shape of a disc, and the annular wall 72 which stands erect upwardly along the outer periphery of the circular plate portion 70. An opening 74 (second opening portion), which is substantially the same configuration as the opening 16, is provided in the circular plate portion 70. At the end portion of the opening 74 at the outer peripheral side of the circular plate portion 70, the bottom portion of the annular wall 72 is cut-out by an amount corresponding to the height of the peripheral wall 44 of the bottom shell 26, and the opening 74 is also open at the radial direction outer side of the inner rotor 20.

As described above, the inner rotor 20 is fit on the inner wall 34 of the top shell 24 so as to be slidable in the peripheral direction, and is supported so as to be rotatable with respect to the case 14, independently of the disk medium 12. Due to the inner rotor 20 rotating (revolving), the inner rotor 20 moves the pair of shutter members 18, which are disposed between the inner rotor 20 and the floor plate 42 of the case 14, between the opening positions and the closing positions while the pair of shutter members 18 slide between the inner rotor 20 and the floor plate 42.

Supporting projections 76 project from two places, which are symmetrical across the center of rotation of the inner rotor 20, at the bottom surface of the circular plate portion 70. The shaft holes 64 of the different shutter members rotatably fit together with the respective supporting projections 76.

Namely, the shutter members 18 are shaft-supported at the inner rotor 20 so as to be freely rotatable around the respective supporting projections 76. The shutter members 18 rotate around the respective supporting projections 76, so as to be able to be set at the closing positions and the opening positions.

As described above, the cam projections 56 of the case 14 enter into the cam grooves 66 of the shutter members 18 so as to form positive motion cams. Due to the inner rotor 20 rotating relative to the case 14, the pair of shutter members 18 are driven between the closing positions and the opening positions.

Specifically, as shown in FIG. 8, when the pair of shutter members 18 are disposed at the closing positions, the opening 74 of the inner rotor 20 is rotated to a position which is offset to the left by a predetermined angle (substantially 50° to 60°) from the opening 16. By the circular plate portion 70 and the annular wall 72, the inner rotor 20 closes the front portion of the opening 16 (the portion which is not closed by the shutter members 18) from the inner side. At this time, the cam projections 56 are disposed in the end portions of the cam grooves 66 which are further away from the shaft holes 64.

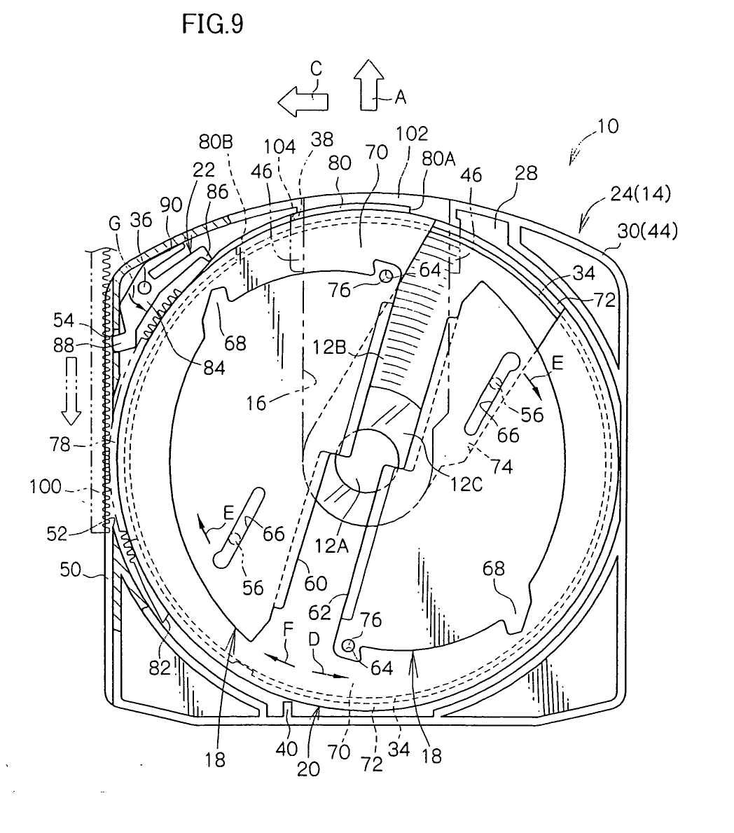

As shown in FIG. 9, when, from this state, the inner rotor 20 is rotated in the direction of arrow D with respect to the case 14, the groove walls of the cam grooves 66 of the shutter members 18 are pressed in the direction of arrow E, which is in substantially the opposite direction as the direction of arrow D, by the cam projections 56, such that the shutter members 18 rotate around the respective supporting projections 76 in directions of moving apart from each other.

Then, as shown in FIG. 10, when the inner rotor 20 rotates to the position at which the opening 74 corresponds to the opening 16 of the case 14, the opposing portions 60, 62 of the shutter members 18 are disposed so as to substantially coincide with the left and right edge portions of the openings 16, 74, and the opening 16 is completely opened (the shutter members 18 have reached their opening positions). In this state, the cam projections 56 are disposed in the end portions of the cam grooves 66 which are nearer to the shaft holes 64.

When, from this state in which the opening 16 is open, the inner rotor 20 rotates in the direction of arrow F which is opposite to the direction of arrow D, due to operations which are opposite to those described above, the pair of shutter members 18 return to the closing positions (the state shown in FIG. 8).

As can be understood from FIGS. 8 through 10, the pair of shutter members 18 carry out movement which includes both rotation of the shutter members 18 accompanying the rotation of the inner rotor 20 with respect to the case 14, and rotation of the shutter members 18 around the supporting projections 76 with respect to the inner rotor 20. However, looking at the shutter members 18 in relation to one another, the movement is such that the shutter members 18 approach and move away from one another while the opposing portions 60, 62 thereof (the cam grooves 66 thereof) are maintained parallel.

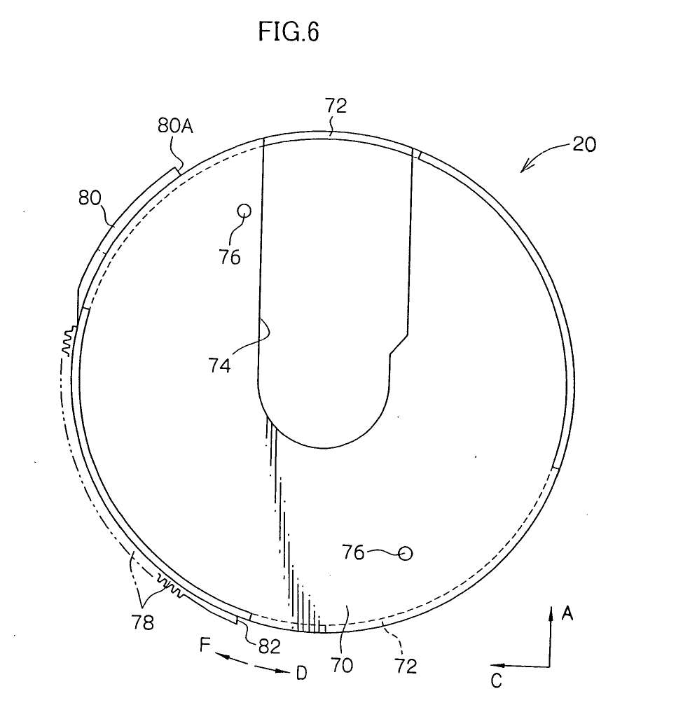

Here, as shown in FIGS. 6 through 8, a driven gear portion 78 (an example of an element of the locking portion) is provided so as to project toward the radial direction outer side from a portion, in the peripheral direction, of the outer peripheral portion of the annular wall 72 of the inner rotor 20. A portion of the driven gear portion 78 projects from the shutter operation window 52 into the guide groove 50.

The driven gear portion 78 is provided at a range in which, in the range of rotation of the inner rotor 20 which moves the shutter members 18 between the closing positions and the opening positions, the driven gear portion 78 can always mesh together with a driving rack 100, which is an opening/closing member at the drive device and which moves in the longitudinal direction within the guide groove 50. In the present embodiment, the driven gear 78 (an example of an element of the locking portion) is provided within a range in which it can engage with (mesh with) an engaging portion 86 which will be described later of the locking member 22 (an example of another element of the locking portion) when the shutter members 18 are disposed at the closing positions.

In this way, when the driving rack 100 moves within the guide groove 50 rearward with respect to the case 14, the inner rotor 20 rotates in the direction of arrow D such that the opening 16 is opened. When the driving rack 100 moves within the guide groove 50 toward the front with respect to the case 14, the inner rotor 20 rotates in the direction of arrow F such that the opening 16 is closed.

As shown in FIG. 6, a closing side stopper body 80 projects radially outwardly from the outer peripheral surface of the annular wall 72, at the arrow F side of the driven gear portion 78 which projects outwardly from the annular wall 72. A step portion 80B (projecting portion) is formed along the peripheral direction at the closing side stopper body 80. The top portion side of the closing side stopper body 80 is long along the peripheral direction, and a stopper portion 80A is provided at the distal end portion.

As shown in FIGS. 8 through 11, when the shutter members 18 are disposed at the closing positions, the stopper portion 80A, which is positioned at the distal end of the top portion side of the closing side stopper body 80, abuts the third stopper 106 of the bottom shell 26, so as to prevent the inner rotor 20 from rotating past the closing position in the direction of arrow F.

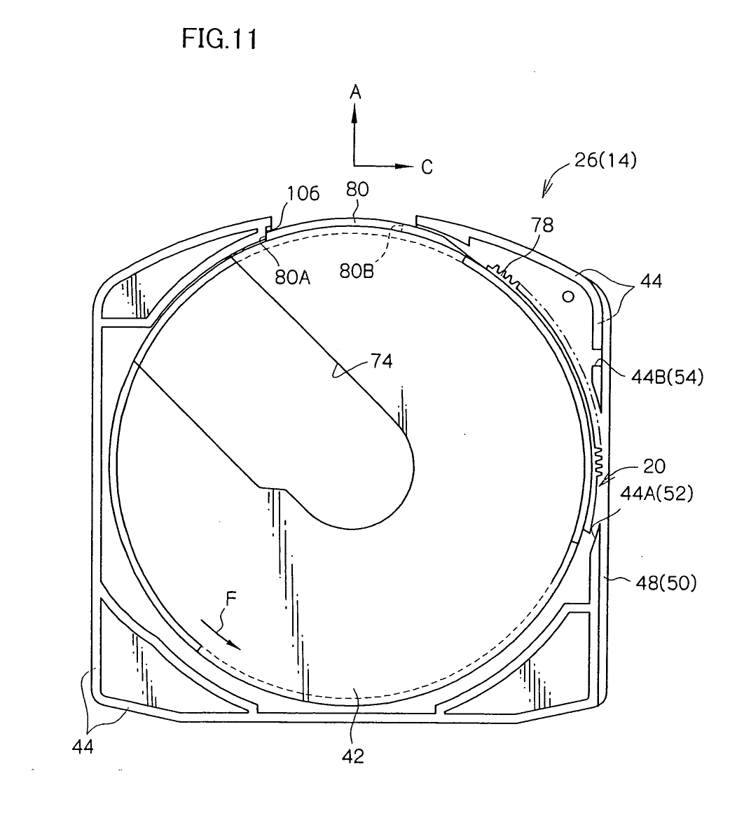

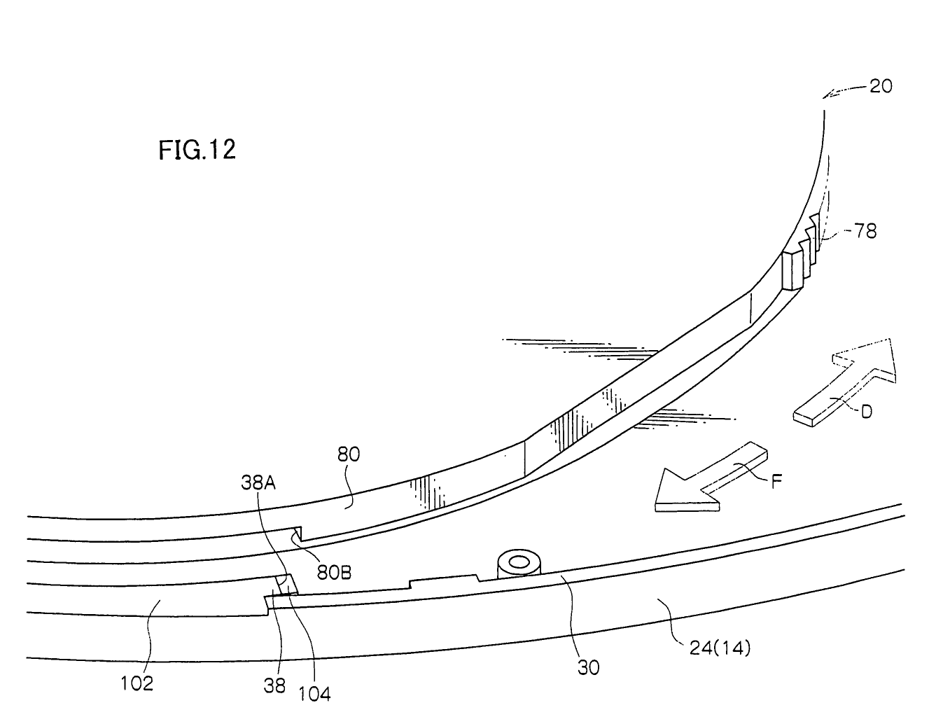

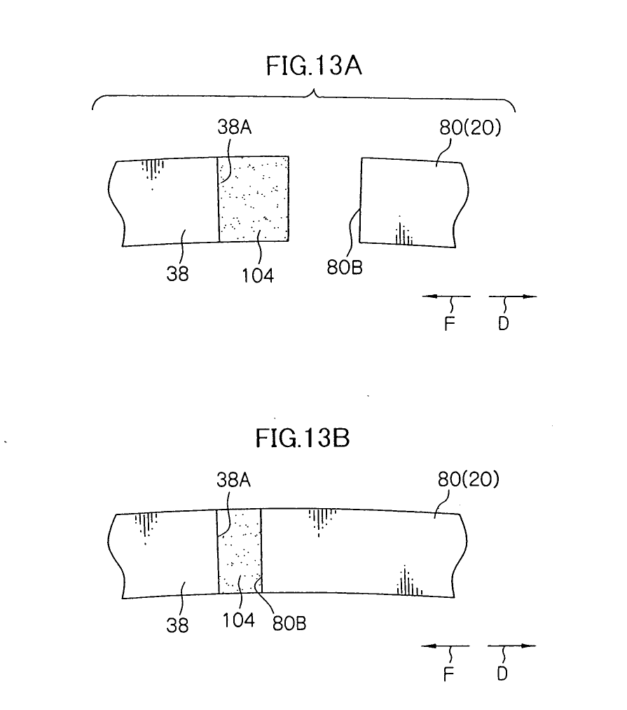

When the stopper portion 80A of the closing side stopper body 80 abuts the third stopper 106 of the bottom shell 26, the step portion 80B shown in FIG. 12 (note that illustration of the locking member 22 is omitted from FIG. 11) abuts the polyurethane foamed member 104 (an example of an urging portion) which is fixed to the distal end surface 38A of the first stopper 38 (an example of a stopper) of the top shell 24 (see FIG. 13B).

As shown in FIG. 6, an open side stopper portion 82 projects from a position of the outer surface of the annular wall 72, which position is apart in the direction of arrow D by a predetermined distance (angle) from the driven gear portion 78. As shown in FIG. 10, when the shutter members 18 are disposed at the opening positions, the open side stopper portion 82 abuts the second stopper 40 of the case 14, and prevents the inner rotor 20 from rotating past the opening position in the direction of arrow D.

The locking member 22 has a main body portion 84 which is substantially V-shaped in plan view. At a vicinity of the bent portion thereof, the main body portion 84 is engaged by the lock supporting shaft 36 of the case 14, and the main body portion 84 is supported so as to be swingable with respect to the case 14 around the lock supporting shaft 36.

One end portion of the main body portion 84 is an engaging portion 86 which can mesh with the driven gear portion 78 of the inner rotor 20. In the state in which the engaging portion 86 is meshed together with the driven gear portion 78, the locking member 22 impedes rotation of the inner rotor 20 with respect to the case 14.

The other end portion of the main body portion 84 is a release operation portion 88 which, as the main body portion 84 rotates around the lock supporting shaft 36, enters into and retreats from the guide groove 50 from the lock release window 54. In the state in which the engaging portion 86 is meshed with the driven gear portion 78, the locking member 22 causes the release operation portion 88 to project into the guide groove 50. When the release operation portion 88 is pushed rearward by the driving rack 100 which moves rearward in the guide groove 50, the main body portion 84 swings in the direction of arrow G, and releases the meshing of the engaging portion 86 with the driven gear portion 78 (see FIG. 9).

A plate spring portion 90 extends from a vicinity of the bent portion of the main body portion 84, so as to run parallel to the front side of the engaging portion 86 side portion. In the state in which the plate spring portion 90 is elastically deformed in the direction of approaching the main body portion 84, the plate spring portion 90 is abutting the peripheral wall 30 at the front side of the case 14, and always urges the main body portion 84 in the direction opposite to the direction of arrow G. Due to the urging force of this plate spring portion 90, the locking member 22 maintains the meshed-together state of the engaging portion 86 and the driven gear portion 78.

In this way, when the disk medium 12 is not in use, rotation of the inner rotor 20 is impeded, and the state in which the opening 16 is closed by the pair of shutter members 18 is maintained. Further, as described above, when, from the lock released state by the driving rack 100, the engagement of the release operation portion 88 and the driving rack 100 is cancelled, the locking member 22, due to the urging force of the plate spring portion 90, returns to the locking state of causing the engaging portion 86 to mesh together with the driven gear portion 78.

Next, operation of the disk cartridge 10 having the above-described structure will be explained.

As shown in FIG. 8, at times when the disk cartridge 10 is not in use, such as is being stored or transported or the like, the pair of shutter members 18 are disposed at the closing positions and close the opening 16. In this state, the engaging portion 86 of the locking member 22 is engaged with the driven gear portion 78 of the inner rotor 20, rotation of the inner rotor 20 in the direction of arrow D is impeded, and the pair of shutter members 18 are held at the closing positions. Namely, the closed state of the opening 16 is maintained.

When the disk cartridge 10 is to be used, i.e., when information is to be recorded onto the disk medium 12 or information recorded on the disk medium 12 is to be played-back, the disk cartridge 10 is loaded in a drive device along the direction of arrow A. Accompanying this loading operation (the relative movement of the disk cartridge 10 and the drive device), the driving rack 100 of the drive device enters into the guide groove 50 of the case 14, and relatively moves rearward within the guide groove 50.

In this way, as shown in FIG. 9, the release operation portion 88 of the locking member 22 is pressed by the driving rack 100, and at the locking member 22, the main body portion 84 swings in the direction of arrow G against the urging force of the plate spring portion 90.

Therefore, the engaged state of the engaging portion 86 with the driven gear portion 78 is cancelled, and the inner rotor 20 becomes able to rotate. When the driving rack 100 moves further rearward while maintaining the state of abutment with the release operation portion 88, the driving rack 100 rotates the inner rotor 20 in the direction of arrow D while meshing with the driven gear portion 78.

Accompanying this rotation of the inner rotor 20 in the direction of arrow D, while the pair of shutter members 18 follow the rotation in the direction of arrow D, the groove walls of the cam grooves 66 are pressed by the cam projections 56 of the case 14 and rotate also in the direction of arrow E around the supporting projections 76

Namely, the pair of shutter members 18 respectively move in directions of opening the opening 16. When the disk cartridge 10 is loaded to a predetermined depth in the drive device and the relative movement between the disk cartridge 10 and the driving rack 100 ceases to exist, as shown in FIG. 10, the pair of shutter members 18 reach their opening positions, and the opening 16 is completely opened.

When, from this state, the inner rotor 20 attempts to rotate further in the direction of arrow D, the open side stopper portion 82 of the inner rotor 20 abuts the second stopper 40 of the case 14, such that rotation of the inner rotor 20 in the direction of arrow D past the opening position is impeded.

Next, the disk cartridge 10 is positioned within the drive device. In this positioned state, the rotating spindle shaft of the drive device enters in from the hub hole 16A of the opening 16. The rotating spindle shaft engages with the center hole 12A (and the chucking area 12C) of the disk medium 12, and holds the disk medium 12. Then, when the rotating spindle shaft rotates, the disk medium 12 is driven to rotate without contacting the interior of the case 14.

The recording/playback head of the drive device enters in from the window portion 16B for a recording/playback head of the opening 16. By the recording/playback head, information is recorded onto the recording surface 12B of the disk medium 12, or information recorded on the recording surface 12B is played back (i.e., the disk medium 12 is used).

After the disk medium 12 has been used, the disk cartridge 10 is ejected from the drive device. Accompanying this ejection, the driving rack 100 moves forward relatively within the guide groove 50. Due to the movement of the driving rack 100, the inner rotor 20 rotates in the direction of arrow F, and the pair of shutter members 18 move toward the closing sides (see FIG. 9).

When the driving rack 100 moves forward and the engaged state of the locking member 22 with the release operation portion 88 is cancelled, the main body portion 84 of the locking member 22 swings in the direction opposite to the direction of arrow G due to the urging force of the plate spring portion 90, and, as shown in FIG. 8, the engaging portion 86 engages with the driven gear portion 78.

In this way, rotation of the inner rotor 20 is impeded, and the pair of shutter members 18 return to the initial state of being held at their closing positions. In this state, the disk cartridge 10 is completely ejected from the drive device.

When, from this state, the inner rotor 20 attempts to rotate further in the direction of arrow F, as shown in FIG. 11, the stopper portion 80A of the closing side stopper body 80 of the inner rotor 20 abuts the third stopper 106 (an example of the stopper) of the bottom shell 26, such that rotation of the inner rotor 20 in the direction of arrow F past the closing position is impeded.

The gist of the disk cartridge relating to the present embodiment will be described next.

As shown in FIGS. 12 and 13A, the parallelepiped polyurethane foamed member 104 is fixed, via an adhesive, to the distal end surface 38A of the first stopper 38 of the top shell 24. As shown in FIG. 8, in the state in which the opening 16 is completely closed and the engaging portion 86 of the locking member 22 is engaged with the driven gear portion 78 of the inner rotor 20 (i.e., in the locked state), the step portion 80B of the closing side stopper body 80 of the inner rotor 20 abuts the polyurethane foamed member 104 and pushes the polyurethane foamed member 104, and elastic force accumulates at the polyurethane foamed member 104 (see FIG. 13B).

In this state, when the locked state of the locking member 22 is released, as shown in FIG. 13A, the polyurethane foamed member 104 is restored, and, via the closing side stopper body 80, urges the inner rotor 20 in the direction in which the opening 16 opens (the direction of arrow D). The inner rotor 20 thereby rotates in the direction of causing the opening 16 to open.

In this way, at the time of opening the opening 16, the inner rotor 20 is urged, by the elastic force of the polyurethane foamed member 104, in the direction in which the opening 16 opens. The rotation of the inner rotor 20 at the time of opening the opening 16 can thereby be made to be smooth.

Namely, in the locked state, in the state in which the step portion 80B of the closing side stopper body 80 is abutting the polyurethane foamed member 104, elastic force is accumulated in the polyurethane foamed member 104. When the locked state of the locking member 22 is released, due to the restoring force of the polyurethane foamed member 104, the inner rotor 20 is urged and rotated in the direction in which the opening 16 opens.

The coefficient of static friction is large as compared with the coefficient of dynamic friction. Therefore, at the time when the inner rotor 20 rotates, in the initial motion thereof, the rotation is unstable. However, due to the polyurethane foamed member 104, at the instant when the opening 16 is opened, the inner rotor 20 is urged in the direction in which the opening 16 opens. In this way, at the time when the opening 16 is opened, the rotation of the inner rotor 20 can be stabilized, and the inner rotor 20 can rotate smoothly.

By urging the inner rotor 20 only at the instant when the opening 16 is opened, the polyurethane foamed member 104 does not have to follow the movement of the inner rotor 20. Therefore, it suffices for the elastic force which is accumulated in the polyurethane foamed member 104 to be small. Thus, the size of the polyurethane foamed member 104 as well can be made to be smaller than in a case in which the polyurethane foamed member 104 is made to follow the movement of the inner rotor 20, and the cost can be reduced by that much.

Here, the parallelepiped polyurethane foamed member 104 is fixed via an adhesive to the distal end surface 38A of the first stopper 38 of the top shell 24. However, although not illustrated, the polyurethane foamed member 104 may be fixed to the end surface of the third stopper 106 of the bottom shell 26 (the portion where the stopper portion 80A of the closing side stopper body 80 abuts), or the polyurethane foamed member 104 may be fixed to the end surface of the first stopper 38 and the end surface of the third stopper 106, respectively.

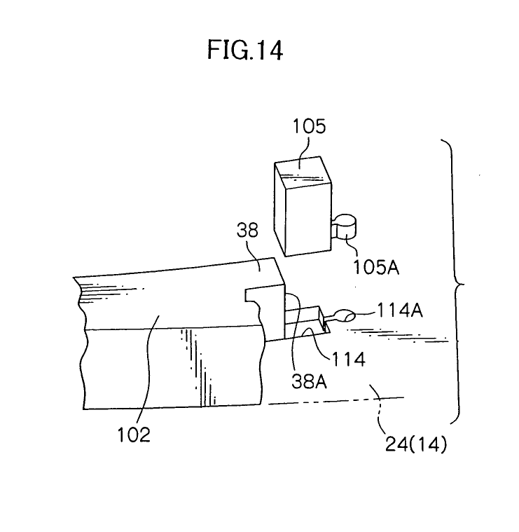

Here, although the polyurethane foamed member 104 is fixed to the distal end surface 38A of the first stopper 38 by an adhesive or the like, the present invention is not limited to the same. For example, as shown in FIG. 14, a concave portion 114, into which the bottom portion of a polyurethane foamed member 105 can fit, may be formed in advance at the place of the top shell 24 where the polyurethane foamed member 105 is to be fixed. The polyurethane foamed member 105 may be fit into this recess portion 114, and fixed to the distal end surface 38A of the first stopper 38.

A fit-together projection 105A is formed at the lower portion of the polyurethane foamed member 105, and a fit-together recess 114A, which with the fit-together projection 105A fits, is formed at the concave portion 114 as well, such the polyurethane foamed member 105 does not shift.

In this way, by forming the concave portion 114 in the top shell 24 and fitting the polyurethane foamed member 105 into the concave portion 114, the polyurethane foamed member 105 can be easily mounted to the first stopper 38 and the workability is good, as compared with a case in which an adhesive or double-sided tape or the like is used.

In the present embodiment, the polyurethane foamed member 104 is fixed to the distal end surface 38A of the first stopper 38. However, it suffices to be able to accumulate elastic force in the state of being abutted by the closing side stopper body 80 of the inner rotor 20. Thus, the present invention is not limited to the polyurethane foamed member 104, and, for example, a rubber member formed of natural rubber or the like may be used, or a coil spring or the like may be used.

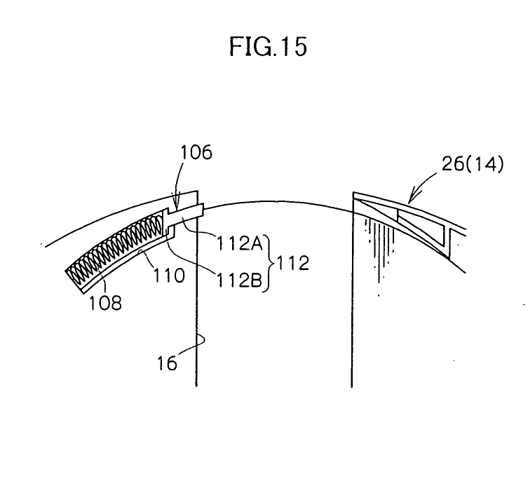

Here, when a coil spring is used, as shown in FIG. 15, a spring accommodating portion 110 is provided at the third stopper 106, and a coil spring 108 is disposed therein. (Because there is the need to ensure space for placement of the coil spring 108 (an example of an element of the urging portion), the coil spring 108 is provided at the bottom shell 26 here. However, the coil spring 108 may be course be provided at the top shell 24.)

One end portion of the coil spring 108 abuts the deep wall within the spring accommodating portion 110. A pin 112 (an example of another element of the urging portion), which is substantially T-shaped in plan view, is attached to the other end portion of the coil spring 108. A neck portion 112A of the pin 112 is exposed from the spring accommodating portion 110. The entrance of the spring accommodating portion 110 is made to be narrow, and a head portion 112B of the pin 112 abuts the peripheral edge portion of the entrance, such that movement of the pin 112 in the direction of pulling-out the pin 112 is restricted.

In this way, in the locked state of the locking member 22 shown in FIG. 8, when the stopper portion 80A of the closing side stopper body 80 of the inner rotor 20 abuts the pin 112, the coil spring 108 is pushed to contract, and elastic force is accumulated thereat. Then, when this locked state is released, due to the restoring force of the coil spring 108 and via the pin 112 and the stopper portion 80A, the inner rotor 20 becomes able to rotate in the direction of opening the opening 16.

In this way, even in a case in which the coil spring 108 is used, the inner rotor 20 is urged only at the instant when the opening 16 is opened, and there is therefore no need to utilize a long coil spring. Thus, as compared with a case in which a long coil spring is used, it is difficult for the coil spring to become entangled, and the assembly workability thereof is good.

Further, here, as shown in FIGS. 8 and 12, the polyurethane foamed member 104 is fixed to the distal end surface 38A of the first stopper 38 of the top shell 24. In the state in which the opening 16 is completely closed and locked by the locking member 22, elastic force accumulates in the polyurethane foamed member 104. When the locked state is released, the inner rotor 20 is urged only the in the direction in which the opening 16 opens. However, the polyurethane foamed member may be fixed to the second stopper 40 of the top shell 24, and may urge the inner rotor 20 also at the instant when the opening 16 is closed.

In the above-described embodiment, the pair of shutter members 18 are supported at the inner rotor 20, and as the inner rotor 20 rotates, the shutter members 18 open and close the opening 16 while moving parallel to one another. However, in the present invention, it suffices for the opening 16 to be closed by the end portions (end surfaces) of the pair of shutter members 18, which are formed as flat plates, abutting one another in a superposed manner. Thus, the present invention is not limited by the configuration, the driving mechanism, and the like of the shutter members 18.

Accordingly, for example, the opening 16 may be opened and closed by a pair of shutter members, which are respectively formed in rectangular shapes in plan view, moving in opposite directions toward the left and the right (i.e., approaching and moving away from one another). Or, the opening 16 may be opened and closed by moving shutter members, which have respectively different configurations, in different directions.

Moreover, the opening 16 is formed only in the bottom of the case 14 in the above-described embodiment. However, the present invention is not limited to the same. For example, in the case 14 which accommodates a disk medium having the recording surfaces 12B at both the top and bottom surfaces thereof, the opening 16 which is opened and closed by the pair of shutter members 18 may be provided also at the ceiling plate 28. In the case 14 which accommodates the disk medium 12 at which the recording surface 12B is provided only at the bottom surface thereof, an opening for replacement, which enables replacement of the disk medium 12, may be provided in the ceiling plate 28.

In the above-described embodiment, the diameter of the disk medium 12 is approximately 120 mm. However, the present invention is not limited to the same, and may of course be applied to the disk cartridge 10 having the disk medium 12 of any dimensions.

In the above-described disk cartridge, a structure is possible in which the inner rotor is urged only at an instant when a locking state of the locking portion is released and the first opening portion and the second opening portion are opened. In such a structure, the inner rotor is urged only at the instant when the first opening portion and the second opening portion are opened.

The coefficient of static friction is large as compared with the coefficient of dynamic friction. Therefore, at the time when the inner rotor rotates, in the initial motion thereof, the rotation is unstable. However, at the instant when the first opening portion and the second opening portion are opened, the inner rotor is urged by the urging portion in the direction in which the first opening portion and the second opening portion open. In this way, at the time when the first opening portion and the second opening portion are opened, the rotation of the inner rotor can be stabilized, and the inner rotor can rotate smoothly.

By urging the inner rotor only at the instant when the first opening portion and the second opening portion are opened, the urging portion does not have to follow the movement of the inner rotor. Therefore, for example, even when the urging portion is a coil spring, there is no need to use a long coil spring so as to suit the amount of movement of the inner rotor. Thus, the assembly workability is improved as compared with a case in which a long coil spring is used. It suffices to be able to accumulate, at the urging portion, an elastic force which is sufficient for urging the inner rotor only at the instant when the first opening portion and the second opening portion are opened. Therefore, the urging portion can be made to be small.

In the above-described disk cartridge, a structure is possible in which the urging portion is provided at a stopper which is formed at a peripheral wall of the case, and a projecting portion, which projects from an outer peripheral surface of the inner rotor, abuts the urging portion. In such a structure, the urging portion is provided at the stopper which is formed at the peripheral wall of the case. In the state in which the projecting portion, which projects from the outer peripheral surface of the inner rotor, is made to abut the urging portion and the inner rotor is locked by the locking portion, elastic force is accumulated at the urging portion.

In the above-described disk cartridge, the urging portion may be an elastic body. Such a disk cartridge has the feature that the elastic body is attached by an adhesive or by double-sided tape. The elastic body can be fixed to the stopper by being attached by an adhesive or double-sided tape.

In a disk cartridge in which the urging portion is an elastic body, a concave portion, with which the elastic body can fit-together, may be formed in the stopper, and the elastic body may be fit in the concave portion. In such a structure, a concave portion, with which the elastic body can fit together, is provided in the stopper. By fitting the elastic body into this concave portion, the elastic body can be easily attached to the stopper, without using an adhesive or double-sided tape or the like.

In the above-described disk cartridge, the elastic body may be any of a polyurethane foamed member, a rubber member and a spring member.

In the case of such a structure, the spring member may be structured by a coil spring disposed in an accommodating portion provided at the stopper, one end portion of the coil spring being abutted by a deep wall of the accommodating portion; and a pin provided at another end portion of the coil spring, a distal end portion of the pin being exposed from the accommodating portion in a state of being unable to be pulled-out from the accommodating portion, and a projecting portion of the inner rotor can abut the distal end portion of the pin. In such a structure, the spring member is structured by the coil spring and the pin, and the coil spring is disposed in the accommodating portion provided at the stopper. One end portion of the coil spring abuts the deep wall of the accommodating portion, and the pin is provided at the other end portion of the coil spring. The distal end portion of the pin is exposed from the accommodating portion in a state of not being able to be pulled out from the accommodating portion. The projecting portion of the inner rotor can abut the distal end portion of the pin. In the locked state by the locking portion in which the projecting portion of the inner rotor abuts the pin, the coil spring is compressed, and elastic force accumulates thereat. When this locked state is released, the coil spring is restored, and, via the pin and the projecting portion, urges the inner rotor in the direction of opening the first opening portion and the second opening portion.

Because the present invention is structured as described above, when the state of locking by the locking portion (the state in which the first opening portion and the second opening portion are closed) is released, the accumulated elastic force is restored, and urges the inner rotor in the direction in which the first opening portion and the second opening portion are opened. The inner rotor thereby rotates in the direction of opening the first opening portion and the second opening portion. In this way, by urging the inner rotor by the elastic force of the urging portion at the time of opening the first opening portion and the second opening portion, the rotation of the inner rotor at the time of opening the first opening portion and the second opening portion can be made to be smooth.

Due to the inner rotor being urged only at the instant at which the first opening portion and the second opening portion are opened, the urging portion does not have to be made to follow the movement of the inner rotor. Therefore, even if the urging portion is a coil spring for example, there is no need to use a coil spring which is long so as to suit the amount of movement of the inner rotor. Thus, the assembly workability is improved as compared with a case in which a long coil spring is used. Further, it suffices to be able to accumulate, at the urging portion, an elastic force which is sufficient for urging the inner rotor only at the instant when the first opening portion and the second opening portion are opened. Therefore, the urging portion can be made to be small.

The elastic body can be fixed to the stopper by being attached by an adhesive or double-sided tape.

Alternatively, by forming the concave portion, with which the elastic body can fit together, in the stopper and by fitting the elastic body into the concave portion, the elastic body can be easily attached to the stopper without using an adhesive or double-sided tape or the like.

1. A disk cartridge comprising:
a disk medium which is loaded in a drive device, and on which information is recorded by laser light, and from which information is played-back by laser light;
a case rotatably accommodating the disk medium;
a first opening portion formed in the case, and enabling projection of laser light onto a recording surface of the disk medium;
an inner rotor rotatably accommodated within the case, a second opening portion of substantially a same size as the first opening portion being formed in the inner rotor;
a shutter supported swingably by a shaft at the inner rotor, and opening and closing the first opening portion and the second opening portion;
an urging portion which, in a state in which the first opening portion and the second opening portion are closed, abuts the inner rotor such that elastic force accumulates at the urging portion, and which urges the inner rotor in a direction of opening the first opening portion and the second opening portion; and
a locking portion locking the inner rotor in a state in which the first opening portion and the second opening portion are closed.

2. The disk cartridge of claim 1, wherein the inner rotor is urged only at an instant when a locking state of the locking portion is released and the first opening portion and the second opening portion are opened.

3. The disk cartridge of claim 1, wherein the urging portion is provided at a stopper which is formed at a peripheral wall of the case, and a projecting portion, which projects from an outer peripheral surface of the inner rotor, abuts the urging portion.

4. The disk cartridge of claim 1, wherein the urging portion is an elastic body.

5. The disk cartridge of claim 4, wherein the elastic body is attached by one of an adhesive and double-sided tape.

6. The disk cartridge of claim 4, wherein a concave portion, with which the elastic body can fit-together, is formed in the stopper, and the elastic body is fit in the concave portion.

7. The disk cartridge of claim 4, wherein the elastic body is one of a polyurethane foamed member, a rubber member and a spring member.

8. The disk cartridge of claim 7, wherein the spring member is structured by:
a coil spring disposed in an accommodating portion provided at the stopper, one end portion of the coil spring being abutted by a deep wall of the accommodating portion; and
a pin provided at another end portion of the coil spring, a distal end portion of the pin being exposed from the accommodating portion in a state of being unable to be pulled-out from the accommodating portion, and a projecting portion of the inner rotor can abut the distal end portion of the pin.

9. A mechanism for rotating an inner rotor used in a disk cartridge comprising:
a case;
a first opening portion formed in the case;
an inner rotor rotatably accommodated within the case, a second opening portion of substantially a same size as the first opening portion being formed in the inner rotor;
a shutter supported swingably by a shaft at the inner rotor, and opening and closing the first opening portion and the second opening portion;
an urging portion which, in a state in which the first opening portion and the second opening portion are closed, abuts the inner rotor such that elastic force accumulates at the urging portion, and which urges the inner rotor in a direction of opening the first opening portion and the second opening portion; and
a locking portion locking the inner rotor in a state in which the first opening portion and the second opening portion are closed.

10. A method of rotating a rotor used in a disk cartridge comprising a case, a first opening portion formed in the case, an inner rotor rotatably accommodated within the case, a second opening portion of substantially a same size as the first opening portion being formed in the inner rotor; an urging portion, and a locking portion, the method comprising:
usually impeding rotation of the inner rotor by the lock member;
accumulating elastic force at the urging portion while rotation of the inner rotor is impeded;
releasing impeding of rotation of the inner rotor by the locking member, when the disk cartridge is to be used; and
urging, by the elastic force, the rotor at which impeding of rotation thereof has been released.

11. The method of claim 10, wherein the elastic force which urges the rotor is restoring force of the urging portion.

12. The method of claim 10, wherein impeding of the rotation of the inner rotor includes the locking member engaging with the inner rotor.
